(19) United States
(12) Patent Application Publication
(10) Pub. No.: US 2020/0136411 A1
(43) Pub. Date: Apr. 30, 2020

(54) Portable Charging Device

(71) Applicant: Tresslyn Valarie Brown, Staten Island, NY (US)

(72) Inventor: Tresslyn Valarie Brown, Staten Island, NY (US)

(21) Appl. No.: 16/172,832

(22) Filed: Oct. 28, 2018

(51) Int. Cl. H02J 7/00; H01R 13/72; H01M 10/46

(52) U.S. Cl. CPC H02J 7/0052; H02J 7/0042; H01R 31/06; H01M 10/46; H02J 2007/0062; H01R 13/72

(57) ABSTRACT

A portable charging device consisting of a battery pack permanently attached to a retractable reel. The retractable reel is connected to a mobile device to charge said device. A power cable is permanently connected to the battery pack. The power cable is connected to a standard wall outlet attachment to recharge the battery pack. The device will be concealed in everyday items such as purses, backpacks, briefcases and diaper bags

### CROSS REFERENCE TO RELATED APPLICATION

This application claims the benefit of U.S. Provisional Patent 62/578,451 filed on Oct. 29, 2017

The above identified patent application is herein incorporated by reference in its entirety to provide continuity of disclosure.

### TECHNICAL FIELD OF INVENTION

The current invention consists of a lithium battery pack, a single side pull retractable reel and a cord to recharge the battery pack. The three components are permanently connected via electric tape or hot glue to create a single unit charging device. The single side pull retractable reel is adapted to supply power to a variety of devices. This device is intended for use as a non removable portable power source to the vehicle it resides.

### BACKGROUND OF INVENTION

Cell Phones and other portable devices have become a core item people carry when leaving the house. People use their phones to play games, watch videos, surf the Internet and so much more. These tasks cause the life of the battery in these devices to be used up quickly. As a result many people face a device that has lost power on a daily basis.

Many people carry external battery packs. Unfortunately, locating a power source when traveling can be difficult.

Current embodiments carrying charging devices have altered the appearance or functionality of the embodiment to make the components accessible to the user. Additionally wires are visible and need to be returned to their compartments. This process is time consuming and can leave bulges where the wires protrude. Additionally, these units require cords that connect the battery charger to the device being charged. Additional adapters may have to be carried depending on the charging device. If one of the components is missing or forgotten the battery pack will not be able to charge the device.

The current invention consists of a compact battery pack that offers a life duration period equivalent to heavier battery packs. The current invention may be easily concealed within a variety of embodiments due to the compact and self contained formation.

The majority of retractable reels require both ends being pulled simultaneously for them to retract without tangling. The use of a single side pull retractable reel in the current invention eliminates the need to attach additional cords. The single side retractable reel works on a spring mechanism allowing it to extend and retract quickly and smoothly. The single side pull retractable reel allows for less wires protruding or having to be tucked in when the device is charged. The cord that extends from the retractable reel of the current invention will only be seen when charging an actual device. The permanently connected charging cable allows the battery back to be recharged via a standard wall outlet.

### DESCRIPTION OF PRIOR ART

Prior Art specifically U.S. Pat. No. 9,722,439 to Williams discloses the need for additional cords to be used in order to charge different devices. These additional ports require additional space and add to the weight of the embodiment.

Prior Art requires access to the battery pack to connect additional charging cables. If access to the battery pack is available the user may choose to remove the battery pack and the invention would not work as intended. Alternatively the cords connected to the battery pack would all be exposed in order to connect to the portable devices. This would take away from the appearance of the embodiment.

Prior Art requires cords to run the length of the vehicle to reach either a power source or the device to be charged.

Prior Art requires a zipper opening to charge the battery unit

Prior Art requires the user to charge their device via a USB connection point attached to a purse or back pack. The user must hold their device next to the connection point making it difficult to use the device that is being charged. Additionally, Prior Art requires modification to fit vehicles beyond a purse.

Prior Art specifically U.S. Pat. No. 8,593,108 to Ferber discloses a specific docking station be inserted into a bag or backpack.

The modifications to accommodate the hardware of the docking station alter the overall appearance and functionality of the embodiment. The Prior Art enables the user to remove the charging system leaving the embodiments without the ability to charge mobile devices as described. Additional cords require clips to be attached to the embodiment.

Prior Art specifically U.S. Pat. No. 9,854,897 to Pelkey discloses a backpack with special pockets created to house the battery pack and cord. These cords are manually connected by the user allowing for misplaced cords in which the charging system no longer functions as intended.

Prior Art specifically U.S. Pat. No. 9,559,535 to Armstrong discloses a separate unit for storing a battery pack. A carrying case for a portable charging device. This requires additional cords and must be carried by hand or in addition to a primary embodiment.

The present invention being a single unit portable charging device is prepared for application into any embodiment.

The present invention is hereby intended to provide a solution to charging portable electronic devices when a traditional wall outlet power source is not available.

A solution for charging portable electronic devices conveniently has not been established in Prior Art.

The permanent connection of the battery pack, single side pull retractable reel and charging cable to make a single unit provides a compact solution not disclosed in Prior Art.

The current invention is intended to be inaccessible once built into the embodiment.

### SUMMARY OF INVENTION

The present invention provides a portable charging device that can be concealed within a variety of embodiments; Thus creating a new embodiment as the portable charging device has become a part of the original embodiment.

The single side pull retractable reel of the current invention provides the convenience of a full length charging cord without the difficulty of returning the cord to a designated space as seen in Prior Art.

The present invention provides a portable charging device that is capable of charging a variety of devices without the use of additional cords or attachments.

The present invention provides a portable charging device that can charge a mobile device while the mobile device is being used.

The present invention provides a portable charging device having a battery pack, a single side pull retractable reel and charging cable that are permanently connected.

### BRIEF DESCRIPTION OF EACH DRAWING

The current invention is constructed with all components permanently connected to create a single unit. The specific function of each components as detailed in the accompanying drawings will provide a better understanding of the manner in which the invention is made and the invention itself.

FIG. 1 shows a side view of the present invention

FIG. 2 shows a full view of the battery pack

FIG. 3 shows a close up view of the single side pull retractable reel

FIG. 4 shows a detailed view of the single side pull retractable reel with two in one android head revealed.

### DETAILED DESCRIPTION OF INVENTION

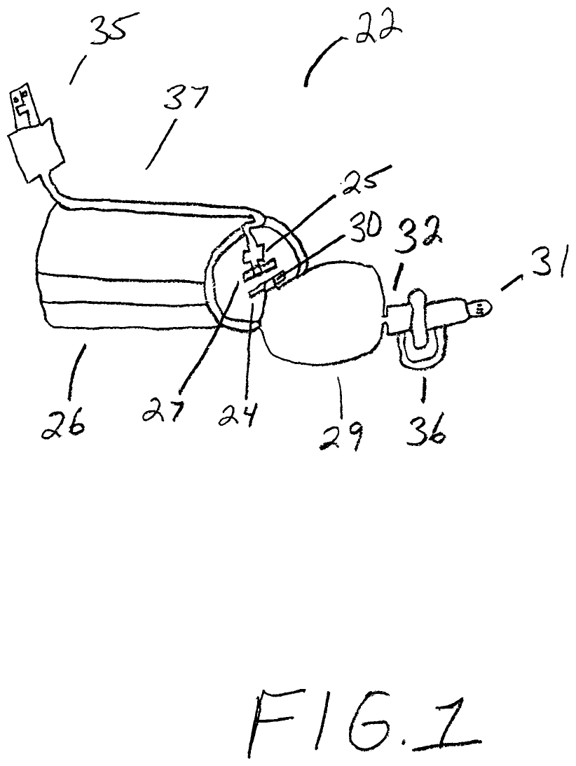

FIG. 1 Shows a sideview of the present invention. The single unit portable charging device 22 consists of a battery pack 26 having a connection port 27 for a micro head charging cable 25. The charging cable 37 has a USB connector on one end of the cord 35. and a micro head connector 27 on the other end. Additionally, the battery pack 26 having a USB port 24 by which the USB connector 30 of the single side pull retractable reel house 29 connects to the battery pack 26.

The single side pull retractable reel 29 connects to the battery pack 26 through the USB connector 30 on the base end of the reel house 29. The top of the single side pull retractable reel house 29 is a two in 1 connector 36 having one end connected to a concealed android head 32 and a iphone head on the other end. 31

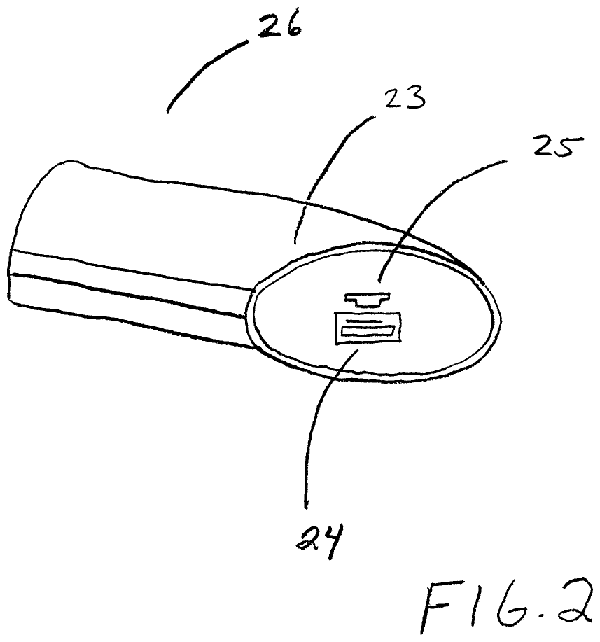

FIG. 2 Shows a detailed view of the battery pack as it functions in the present invention 22. The battery unit 26 having a micro head port 25 in the top portion of the battery unit 26 head, with a USB port 24 in the bottom portion of the battery unit 26 head. 23 shows indicator light to identify when the unit is fully charged.

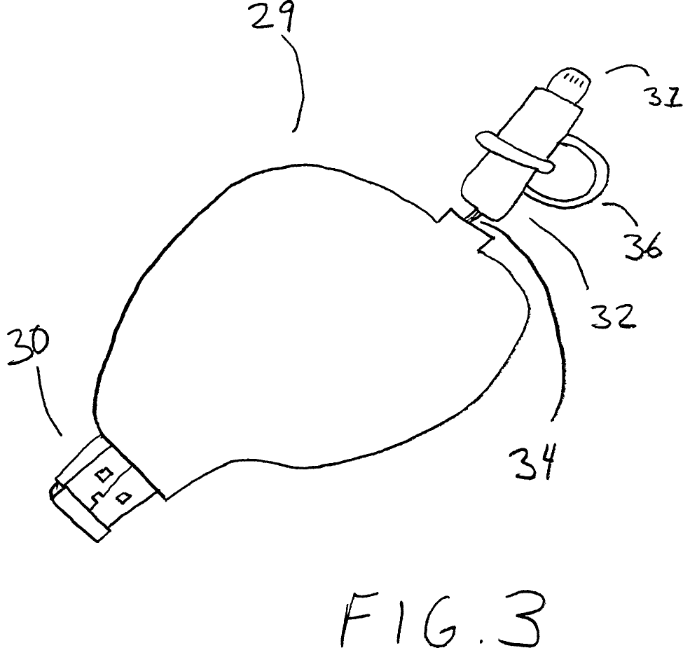

FIG. 3 Shows retractable reel housing unit 29 containing a reel 34 that functions as a single side pull connected to a two in one head consisting of a concealed android head 32 an iphone head 31 with a connector attached to both heads 36. The base end of the single side pull retractable reel house 29 having a USB connector. 30

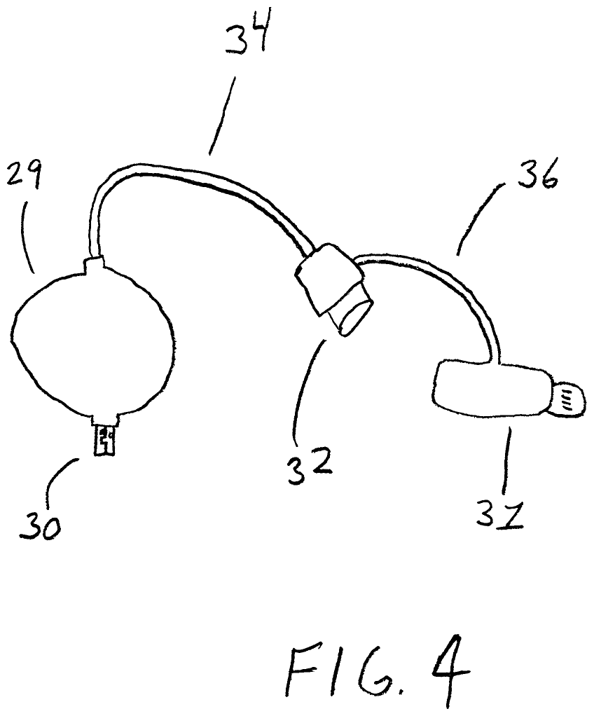

FIG. 4 Shows retractable reel housing unit 29 with the retractable reel extended 34. The android head 32 is revealed and shows the function of the two in one connector 36 as it is attached to the iphone head on the other end. The base end of the single side pull retractable reel house 29 having a USB connector. 30

1. A portable charging device that consists of a battery pack having a USB port and micro USB port on one end, a single side pull retractable reel connected to said battery pack via the USB port and a power cable connected to said battery pack via the micro USB port.

2. The portable charging device of claim 1 consists of a single side pull retractable reel having a two in one connector for multi mobile device charging, permanently connected to the said battery pack by a USB port connection.

3. The portable charging device of claim 1 consists of a power cord that is connected to the said battery pack by micro USB connection.

4. The portable charging device of claim 1 consists of a battery pack, a single side retractable reel and a power cable permanently connected to create a single device.
